(19) United States
(12) Patent Application Publication
(10) Pub. No.: US 2014/0358888 A1
(43) Pub. Date: Dec. 4, 2014

(54) Method, System, And Computer Program Product For Monitoring Online Reputations With The Capability Of Creating New Content

(71) Applicant: Reputation Rights, LLC, (unknown)

(72) Inventors: Granger WHITELAW, Delray Beach, FL (US); Richard KANE, Wellington, FL (US); Scott Jeffrey EMRICH, Ocean Ridge, FL (US); Steven MENDELSON, Westport, CT (US)

(73) Assignee: Reputation Rights, LLC

(21) Appl. No.: 14/289,048

(22) Filed: May 28, 2014

Related U.S. Application Data
(60) Provisional application No. 61/828,052, filed on May 28, 2013.

(51) Int. Cl. G06F 17/30; H04L 29/08

(52) U.S. Cl. CPC G06F 17/30864; H04L 67/22
USPC 707/709; 707/748; 707/722

(57) ABSTRACT

The present invention provides the capability to quickly and easily determine the online reputation a target, and to quickly and easily take steps to improve the online reputation of the target. For example, a method of monitoring and affecting online reputation may comprise gathering information potentially related to an online reputation of a target, filtering the gathered information to eliminate information not related to the target, computing a reputation score for the filtered information based on both positive and negative information related to the target, generating positive information relating to the target, and distributing the generated positive information relating to the target to a plurality of online locations.

### CROSS-REFERENCE TO RELATED APPLICATIONS

This application claims the benefit of Provisional Application No. 61/828,052, filed May 28, 2013, the contents of which are incorporated herein in their entirety.

### BACKGROUND OF THE INVENTION

1. Field of the Invention

The present invention relates to a social media method, system, and computer program product. Specifically, the present invention relates to a method, system, and computer program product for monitoring online reputations with the capability of creating new content by seamlessly integrating a disparate group of social media tools.

2. Description of the Related Art

Social media has become an increasingly prevalent form of communication and interaction. However, the ease of entering information, the anonymity provided by such media, and the persistence of information on the Internet, has made it increasingly likely that negative information about a particular target, such as a person, product, or company, may accumulate online. In addition, the vast number of online locations that may contain information about a particular target makes it difficult to determine the overall online reputation of such a target. A need arises for parties to quickly and easily determine the online reputation a target, and to quickly and easily take steps to improve the online reputation of the target.

### SUMMARY OF THE INVENTION

The present invention provides the capability to quickly and easily determine the online reputation a target, and to quickly and easily take steps to improve the online reputation of the target. For example, techniques described herein may provide the capability to perform monitoring to: search News, General Web, Image, twitter and industry specific feeds and search tools; store and recognize websites, Social Media Profiles, Microblogs, blogs, etc. as already identified, categorized, changed; select which websites, Social Media Profiles, Microblogs, blogs, etc. are on target using AI scoring and human intervention to train AI scoring; evaluate a sentiment value of each word in a websites, Social Media Profiles, Microblogs, blogs, etc. against an industry and individual specific dictionary for emotional content and of accumulating that score; weight websites, Social Media Profiles, Microblogs, blogs, etc. based on its rank in a search, its sentiment value, and its weight by the source of the information; score the accumulated weighted posts into a reputation index; and track the reputation index over time to monitor changes in reputation.

As another example, techniques described herein may provide the capability to: identify the posters of negative content via a honey pot Uniform Resource Locator (URL), gather information about an entity clicking on a URL including the originating IP address, operating system, and device originating the click; track and highlight individual posts for follow up with a task specific work flow engine; and automate and orchestrate the response to websites, Social Media Profiles, Microblogs, blogs, etc., by applying posts auto generated from templates, create legal documents auto generated from templates, and retweet and post links to positive content thereby improving the visibility of positive content.

As another example, techniques described herein may provide the capability to implement Link building techniques to tie web properties and social media together directly and indirectly. For example, direct link building may include posts from EMD sites and blogging platforms being syndicated to the microblogging platforms automatically via programming scripts and third-party applications. As another example, In-direct link building may include proprietary design of indirectly interlinking web properties that generate links to the primary sites to avoid unnatural link-building penalties from the search engines.

As a further example, a method of monitoring and affecting online reputation may comprise gathering information potentially related to an online reputation of a target, filtering the gathered information to eliminate information not related to the target, computing a reputation score for the filtered information based on both positive and negative information related to the target, generating positive information relating to the target, and distributing the generated positive information relating to the target to a plurality of online locations.

The information may be gathered from a plurality of online locations, at least one online location provided by the target or a representative of the target, and at least one online location found in a keyword search. The keyword search may be performed using at least one search engine and using at least one search term found by crawling the keyword search tools of the search engine to find search terms used in connection with a specific root keyword. The filtering may be performed based on at least one of geographic location, employer, company, interest, hobby, and keywords. The filtering may be performed based on input provided by the target or a representative of the target indicating whether or not particular information or a particular online location is related to the target. The reputation score may be computed by for each piece of gathered information relating to the target, scoring each word in the piece of gathered information using information indicating relevance and importance of particular words in particular industries, and accumulating the total score for the piece of gathered information, for each of a plurality of highest scored pieces of gathered information, weighting the score of the piece of information based on a rank of the piece of information among the gathered information, and weighting the score of the piece of information based on a specific online location from which the piece of information was gathered, and computing the reputation score from the weighted scores of the plurality of the highest scored pieces of gathered information. Positive information relating to the target may be generated by at receiving positive information from the target or a representative of the target. The generated positive information may be distributed to a plurality of online locations by performing at least one of automatically logging into at least one online location controlled by the target or a representative of the target, including at least one of a social media account, a blog account, and a website owned or controlled by the target or a representative of the target, automatically creating at least one online location controlled by the target or a representative of the target, including at least one of a social media account and a blog account, and automatically obtaining a domain name and creating a website owned or controlled by the target or a representative of the target, and distributing the generated positive information to the plurality of online locations.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a system for monitoring online reputations with the capability of creating new content.

FIGS. 2a-c is an exemplary process flow diagram for a method of monitoring online reputations with the capability of creating new content.

FIG. 3 is an exemplary diagram of a process of computing a reputation score.

FIG. 4 is an exemplary process flow diagram for a method of monitoring online reputations with the capability of creating new content.

FIG. 5 is an exemplary diagram of a process of computing a reputation score.

FIG. 6 is an exemplary block diagram of components and the environment of a system for monitoring online reputations.

FIG. 7 is an exemplary block diagram of a computer system, in which the processes described herein may be implemented,

### DETAILED DESCRIPTION OF THE INVENTION

The present invention provides a technique to engage consumers as active participants in better managing their health. The present invention includes a social media platform that leverages the power of celebrity brands to engage consumers as active participants in better managing their health. The platform combines the essential values of social networking (such as Facebook™), micro blogging (Twitter™), and social commerce (LivingSocial™), with a particular focus on health.

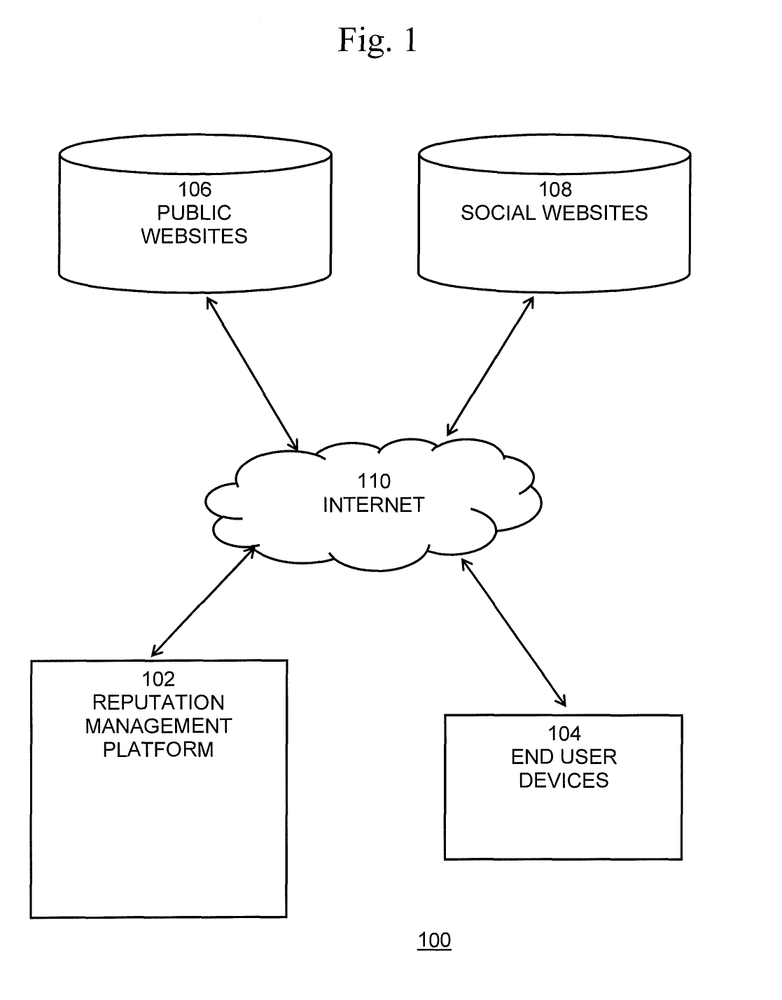

An exemplary system for monitoring online reputations with the capability of creating new content is shown in FIG. 1. The system of FIG. 1 includes, but is not limited to, the reputation management platform 102, end user devices 104, public websites 106, such as search engines, and social websites 108, all of which may be coupled together over a communications network, such as the Internet 110. The reputation management platform 102 typically includes, but is not limited to, a CPU, memory, network interface and computer program instructions stored in memory and executed by the CPU to implement the functions and method disclosed herein. The end user devices 104 may include devices such as personal computers, workstations, tablet computers, smartphones, etc., that implement one or more standard browsing platforms to issue requests for the reputation management platform 102 to perform the function described herein.

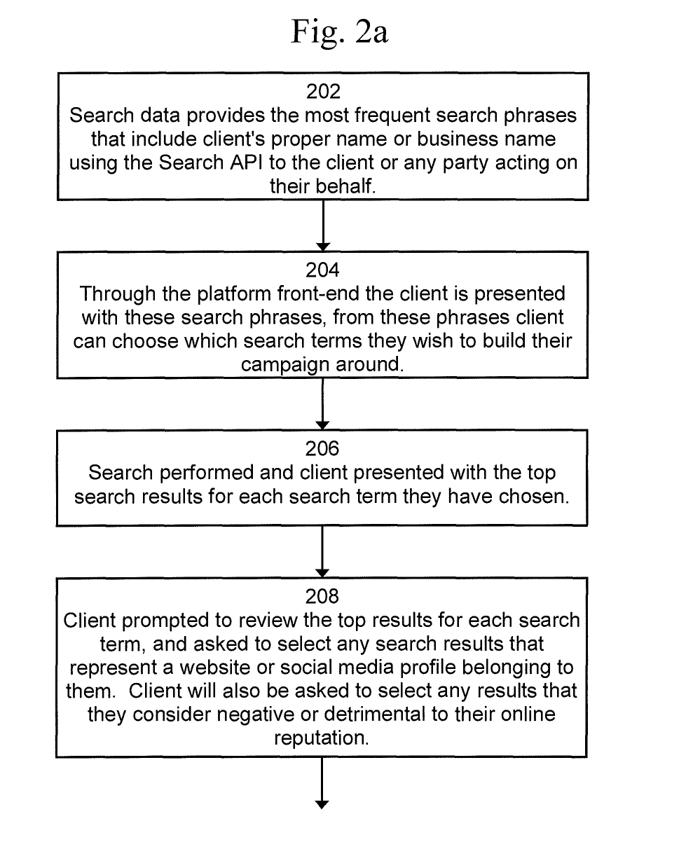

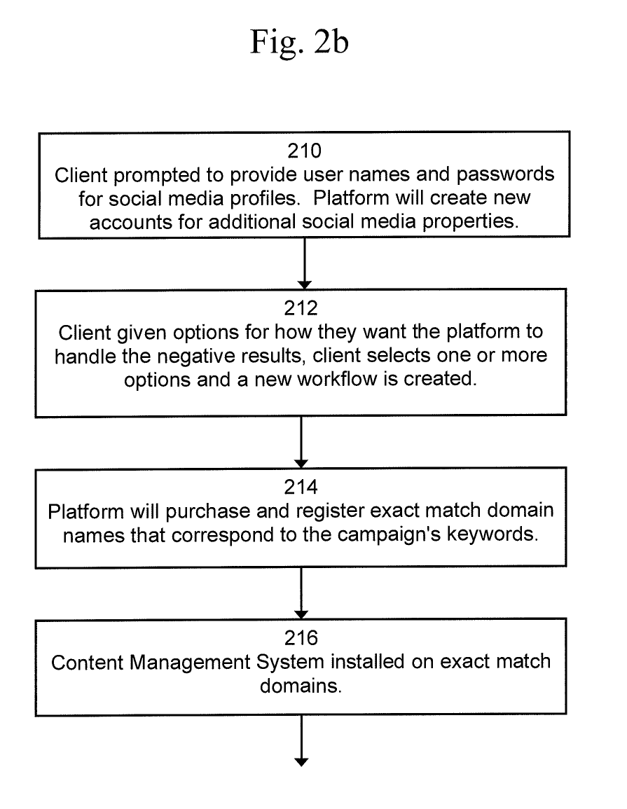

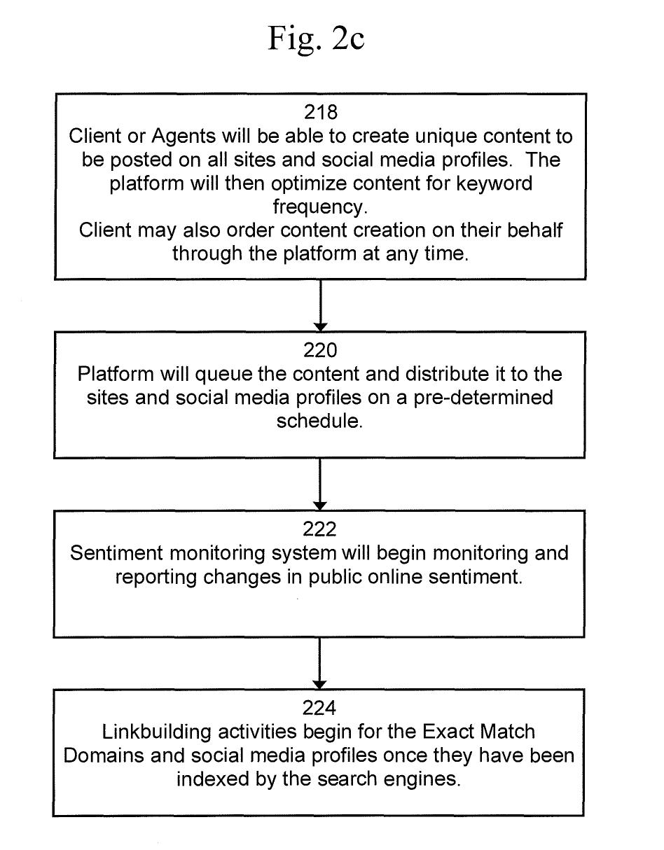

An example of a method of monitoring online reputations with the capability of creating new content is shown in FIGS. 2a-c. In the example shown in FIG. 2, the methods implemented by the reputation management platform 102 include, but are not limited to, discovery and subsequent targeting of the most relevant organic keyword search terms, Social Media and Web Property creation, content deployment across a network of interconnected web properties and social media profiles

The method shown in FIGS. 2a-c begins with step 202, shown in FIG. 2a, in which search data is received including the most frequent search phrases that include a target's (person, product, company, etc.) proper name or business name using a Search API to the target or representative of the target. The most relevant keyword search terms are discovered and subsequently targeted using search data obtained from major search engines. The method of discovering and subsequently targeting the most relevant keyword search terms may include the reputation management platform 102 using custom programmed scripts to crawl the keyword search tools of the major search engines, such as news, web and Images APIs, to discover search terms used in connection with a specific root keyword. For example, a search engine API may list the ten most popular search terms (e.g., “When was George Washington born,” “Did George Washington have children,” etc.) relating to a specific root keyword (e.g., George Washington). Each of the search terms may contain the root keyword, and represent the most relevant search terms that the reputation management platform 102 examines and monitors. A specific root keyword may include, but is not limited to, a person, an entity, a place, and a thing.

The search terms may be a number of the most popular terms used in connection with a search for the specific root keyword. For example, the search terms may be a fixed number, such as 5, of the most popular terms used in connection with a search for the root keyword. For example, search terms may be a range, such as 1-3, 3-5, and 5-10, of the most popular search terms used in connection with the specific root keyword. For example, a specific root keyword may be an entity or individual for which an online reputation is being determined.

In one example, the method of discovering and subsequently targeting of the most relevant keyword search terms may include the reputation management platform using custom programmed scripts that create searches for chosen root keywords. For example, a user, who may be a target or representative of the target, may be prompted to enter the root keyword, such as the person's name, a product name, a business name, etc. For example, John Doe. Now the reputation management platform may interface with a search engine using a developer key or the like. In this example, the reputation management platform may collect the most popular search terms, for example: John Doe retired, John Doe stats, John Doe ex-wives, John Doe 2013, etc. . . .

In step 204, through the platform front-end, the user is presented with these search phrases. From these phrases, the user can choose which search terms they wish to build their campaign around. That is, the user can choose which of the discovered search terms they wish to target. Various options may be available to the user. For example, the entity or individual may choose which of the discovered search terms to omit. The entity or individual may request additional search terms to add to the list of discovered search terms. The search terms may be scored or ranked based on relevance. The websites discovered using the search terms may be ranked by a value or score given to a website. Websites may be given a sentiment value based on the content disclosed by the website. Specific words used in a website may have a positive or negative weight or value. Thus, the user may have the opportunity to choose which search terms they wish to target, which terms to omit, and request additional search terms to be added.

In step 206, searching is performed using the selected search terms and the user presented with the top search results for each search term they have chosen. In step 208, the user is prompted to review the top results for each search term, and asked to select any search results that represent a website or social media profile belonging to them. The user will also be asked to select any results that they consider negative or detrimental to the target's online reputation. For example, the user may compile a list of separate sites discovered using each of the most popular search terms that the target or representative of the target may designate as their own. These may be Social Media, Business directories, professional listings, (e.g., LinkedIn, Industry associations) Blogs, etc. These separate web sites may all be directly controlled by the target, or some or all may not be controlled by the target. In step 210, the user may be prompted to provide login information via the reputation management platform so as to automate content posting to these properties. In addition, the platform may create new accounts for additional social media properties. A database of websites will be built by the reputation management platform.

Returning to step 208, the user may compile a list of separate sites discovered using each of the most popular search terms that the user will select to disavow. For example, web sites that can be disavowed include, but are not limited to, social media properties for a different individual or business with the same name as the target, but that show up in search results for the target. This enables the tracking of irrelevant sites that are generated in the list of separate web sites, and ensure that only sites relevant to the target are added into the reputation management platform's workflow.

Likewise, in step 208, the user may compile a list of sites with negative information directed to the target. In an embodiment of the invention, these sites may include, but are not limited to, business review sites, blogs, and/or consumer complaint sites. In one example, the method of discovering and subsequently targeting of the most relevant search terms may include the reputation management platform using custom scripts that scan the results discovered using the most popular search terms and then feed the data from the results into the reputation management platform for storage in memory. In another example, the reputation management platform may be operable to allow a target to log-in to a page created for the target for the target to assign pre-determined values to each of the results discovered by each search term.

In step 212, the target may be given options for how they want the platform to handle the negative results. The target may select one or more options and a new workflow is created. For example, a user may select ‘Offset Social Posting’, which can introduce a unique workflow designed to create new web sites, or new postings on existing websites, that included positive information. This workflow can provide postings to multiple sites, such as 100 or more sites, such that eventually these new sites and postings rank ahead of the chosen site that includes negative information. Likewise, in step 214, described below, the reputation management platform may automatically create new web properties.

In another example, when a site contains negative information, a user may choose to pursue legal action relating to the web site. This may trigger workflow choices that allow the end-user to complete relevant legal documents selected from a library of boilerplate legal documents stored in the reputation management platform. In another example, the user may choose to attempt to locate anonymous content posters of negative information on a web site through a proprietary investigative tool within the reputation management platform.

In step 214, the reputation management platform may automatically create new web properties. The platform may purchase and register exact match domain names that correspond to the campaign's keywords. A web property includes, but is not limited to, content which the target owns or has direct control of, including but not limited to Social Media Profiles, Microblogs (Twitter, Instagram), Blogs, and any websites owned by the person or the business for which they or any employees maintain control of any and all content posted on these web properties. In an embodiment of the invention, the user may have the choice of any and all search terms which they desire to have different web properties show up in the results. For example, if the search term “Burger King West Philadelphia” returned negative results that reflect poorly on that location, the reputation management platform can then build new web properties and bolster existing web properties that show up when someone uses that search term, thereby displacing the negative websites associated with that term to a less influential position in the search rankings. For example, placing the negative website at the end of the search results is a less influential position.

Social Media profiles (Facebook, Twitter, Pinterest, Tumblr, etc.) and new Exact Match Domain (EMD) websites (e.g., free standing sites on domains owned by the target), as well as additional domains may be acquired and registered via the reputation management platform. In this context, Exact Match Domains (EMDs) includes internet domains that contain any of the keyword search terms that the user has chosen to focus the reputation management platforms capabilities upon.

For example, custom scripts are utilize by the platform to use the selected search terms to create Exact Match sub-domains on the most popular social media platforms. Each search term will generate an automated workflow task to create new accounts on the chosen social media platforms. Likewise, for example, scripts automate the entire process of identifying, purchasing, registering, and verifying new social media accounts removing the need for human interaction at the individual account level.

In step 216, EMD site creation is performed using a content management system (“CMS”) that may be automatically installed. A content management system (CMS) manages the contents of a Web site. The CMS is used to manage the creation and modification of content on a website. Pre-formatted CSS themes are installed automatically, along with a zip file of 3rd party plugins to aid in site management and automation of common tasks such as: site map generation, internal page linking, on-page SEO, connecting the site to outside blogging platforms (wordpress.com, blogger.com) and microblogging platforms (twitter, Tumblr, Pinterest). Themes are pre-programmed templates that determines the layout and functionality of a website. Themes allow content to be added to the theme to create a new fully functioning website with a fraction of the programming needed for a traditionally programmed website.

In step 218, users will be able to create unique content to be posted on all sites and social media profiles. The platform will then optimize content for keyword frequency. Users may also order content creation on their behalf through the platform at any time. For example, the reputation management platform may deploy content across a network of interconnected web properties and social media profiles. The user may create and post content themselves through the reputation management platform. The reputation management platform interface allows the user to create unique content targeting social media sites with their unique constraints as well as content for the target's full scale websites. Likewise, content may be created by the user. The user may create content in any manner they choose or the user may create content according to guidelines included in the platform software. For example, the guidelines may include, but are not limited to, content size (character or word count), content frequency (how often it is posted online), keyword frequency (how often as a percentage of the text that the keyword shows up in each piece of content, etc. The content may be ordered via the platform for creation if the user does not have the capability or desire to create their own content. Content orders may flow to third party contractors either through the platform or manually by a Reputation Rights employee.

Further in step 218, content may be automatically keyword optimized for the chosen keyword search term that each property has been built around. Keyword optimization may include the creation of a site to focus on one or more specific search terms so as to be selected by search engines as highly relevant to that search term. For example, a site optimized for “Burger Restaurant West Philadelphia” would contain those words in the titles, in the content, include a map of its location in West Philadelphia, etc. The site would not include detailed information about other locations, so that search engine algorithms would understand that the site is highly relevant to anyone searching for a Burger Restaurant in West Philadelphia. Manually created content may undergo keyword analysis and prompt the end-user to add or remove keyword terms based on pre-configured parameters of one, two, and three word combinations as a percentage of the text.

Once the user has requested content creation via the platform, the content has been created and uploaded via the platform, and any new content has been approved by the user, in step 220, the platform will queue the content and distribute it to the sites and social media profiles on a pre-determined schedule. For example, the content queue includes a collection of pre-written content (e.g., tweets, blog posts, website articles, white papers, etc.) that has been programmed to be posted online in advance of the actual posting date. Content queue may be created according to pre-determined parameters that will produce automated content recommendations based on a set of variables programmed into the platform. For example, a variable 1 may correspond to number of websites and blogs. A variable 2 may correspond to the number of social media properties in use. A variable 3 may correspond to content posting frequency, where, for example, blog posts—1 or 2 times per week, micro-blog posts (Twitter, Tumblr, Pinterest)—5 per day, industry related articles—1 per month, and white papers—1 to 4 per year. Content may then be deployed automatically from the queue on the pre-determined schedule.

Once the new content has been deployed, in step 222, the sentiment monitoring system will begin monitoring and reporting changes in public online sentiment on an ongoing basis. The new content that has been deployed should, over time, affect the overall online sentiment in the desired direction. In addition, in step 224, link-building activities begin for the Exact Match Domains and social media profiles once they have been indexed by the search engines. As these activities occur, the overall online sentiment should continue to be affected in the desired direction.

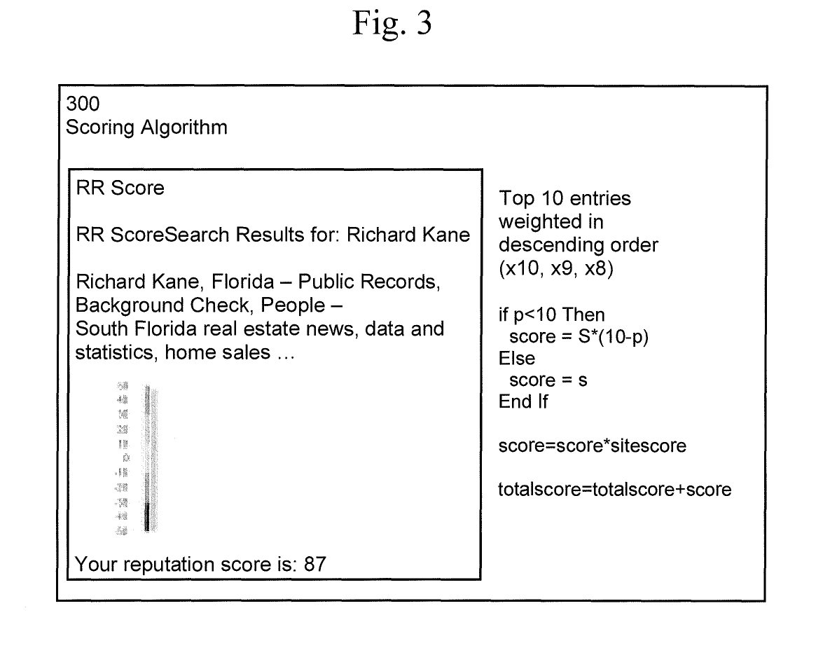

An example of a scoring algorithm 300 is shown in FIG. 3. In this example, a reputation score (RR Score) is computed. The RR score includes the top 10 entries in the search results found in step 206 of FIG. 2. The top 10 entries may be weighted in descending order, such as the top entry is multiplied by 10, the next entry is multiplied by 9, etc., and added to yield the score. If the number of entries, p, is less than 10, then the score=the score*(10−p), otherwise the score is not further adjusted. The score may be displayed to the user using a format such as that shown in FIG. 3.

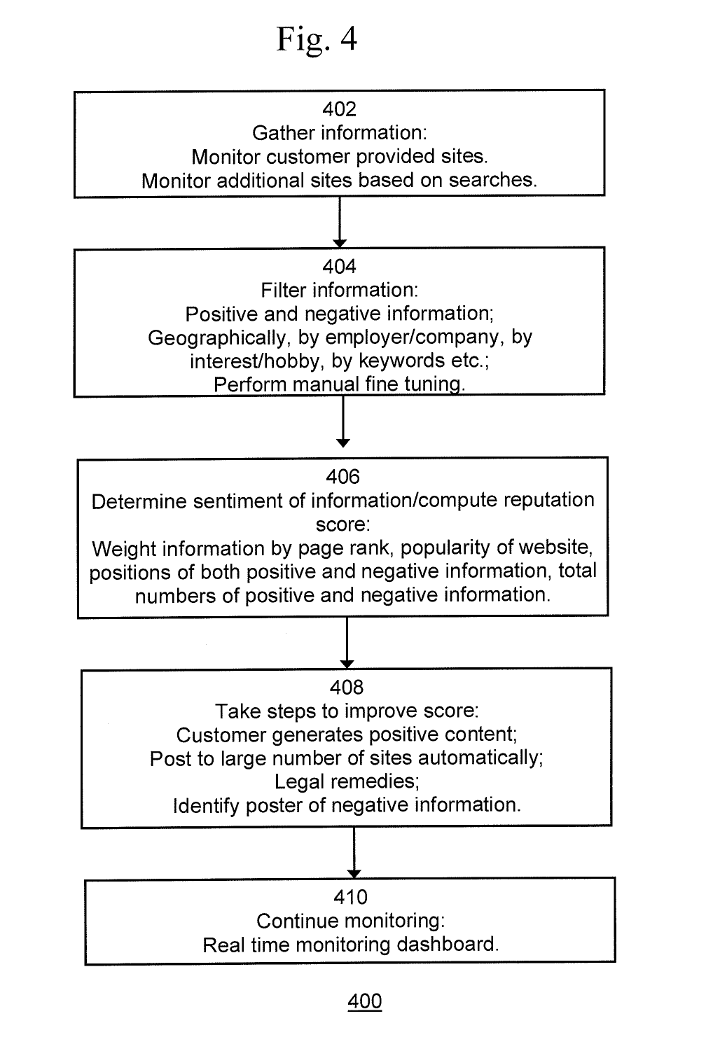

Another example of a method 400 of monitoring online reputations with the capability of creating new content is shown in FIG. 4. Method 400 begins with step 402, in which information relating to the online reputation of the target is gathered. Such information may be gathered from sites provided by the user, and may also be gathered from additional sites based on searches, such as those performed in process 200.

In step 404, the gathered information may be filtered based on a number of criteria. For example, information may be filtered based on whether the information is positive or negative. Likewise, the information may be filtered based on geographic location, by employer/company, by interest/hobby, by keywords, and by other criteria in order to eliminate information about the wrong people/companies. That is, people/companies having similar names to the target, but who are not the target, may be identified and information relating to these incorrect parties may be eliminated from the set of gathered information. Likewise, sites that relate to these incorrect parties may be eliminated from those sites that are searched in future. In addition, manual fine tuning may be performed, if necessary, by the target. The fine tuning may be captured by the platform and used to generate additional filters to reduce future manual work.

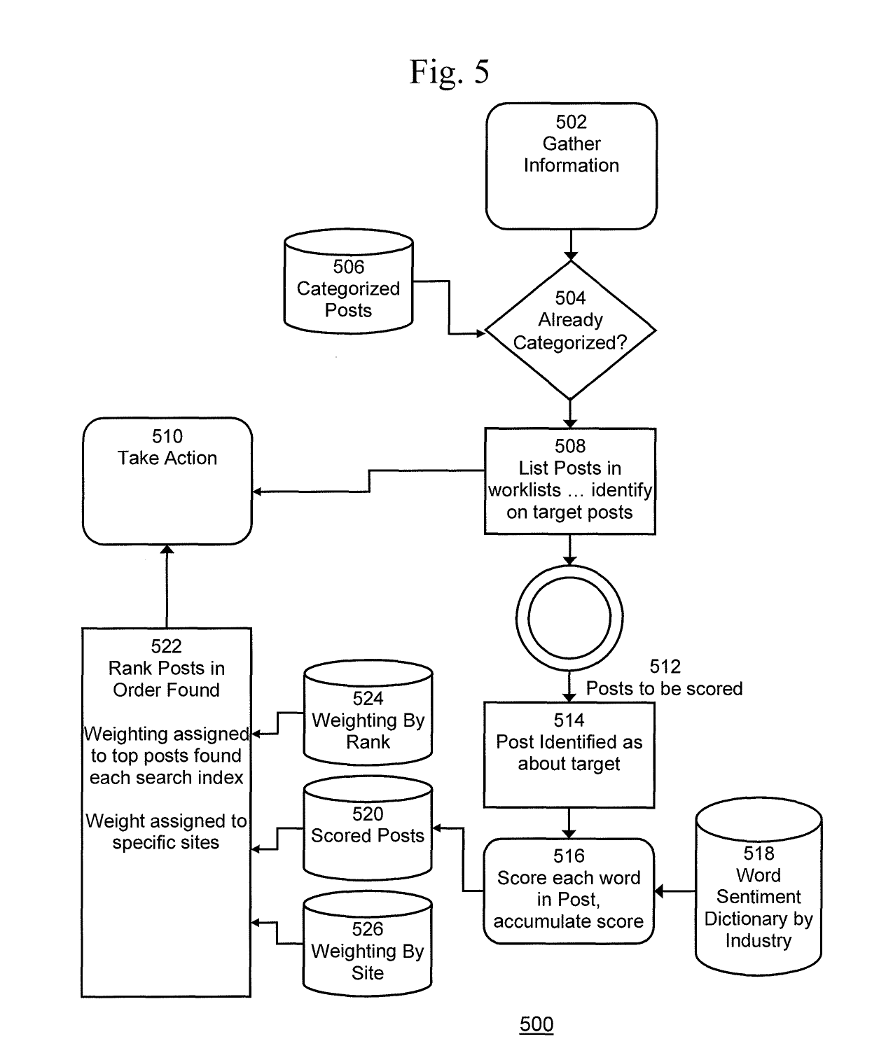

In step 406, the sentiment of information is determined and reputation score is computed. A number of criteria may be considered in computing the reputation score. For example, information may be weighted by factors such as page rank, popularity of the website, positions of both positive and negative information, total numbers of positive and negative information, etc. A more comprehensive process may be used to compute the reputation score, such as that shown in FIG. 5 below.

In step 408, steps may be taken to improve the reputation score of the target. Some of these steps are interactive processes between the platform and the user, while some steps are automatically performed by the platform once initiated by the user. For example, the user can interactively generate positive content, for example, as described in relation to step 218, shown in FIG. 2. Once the positive content has been generated, the platform can post the content to a large number of sites automatically, for example, as described in relation to step 220, shown in FIG. 2. As described, the positive content may be posted to existing websites, as well as to newly-created websites. The user can interactively use tools/templates for legal remedies, such as take down and/or cease and desist letters, legal action, etc., for example, as described in relation to step 212, shown in FIG. 2. In addition, the platform may provide information and/or tools to aid the user in identifying posters of negative information. Such information and/or tools may include service requests, social engineering, etc.

In step 410, monitoring of reputation-related information and computation of the reputation score is continued in order to determine the effects of the steps taken to improve the reputation score, as well as to determine external trends in the reputation of the target. The reputation-related information may be gathered periodically and/or continuously, and the reputation score may be computed and displayed in real-time. A tool for such real-time monitoring, computation, and display, such as a real-time monitoring dashboard may be provided by the platform.

An exemplary process 500 for computing the reputation score is in FIG. 5. Process 500 begins with step 502 (also shown as step 402 in FIG. 4), in which information, typically in the form of posts, relating to the online reputation of the target is gathered. For example, site-specific Application Program Interfaces (APIs) may be used to search news sites, the Web in general, Web images, etc. for information relating to the target. Many new sites, search sites, and other websites provide such APIs in order to simplify searches for desired information. In addition, websites may be searched without using APIs. This provides the capability to search sites that do not provide APIs, as well as possibly providing different results from sites that do provide APIs.

In step 504, the gathered information is analyzed to determine in it has already been categorized. For example, the gathered information may be compared with information stored in a database 506 of categorized posts to determine the portions of the gathered information that has already been categorized. Particular relevant categorizations may include whether or not the post relates to the target, whether the information is positive or negative, etc.

In step 508, the gathered information may be organized into work lists to be worked on in step 510. The work lists may be organized based on the information that is identified as being about the target. The information that is already categorized can be organized as is, while the uncategorized information must be categorized and scored. Thus, in step 512, the information to be scored may be identified. In step 514, the information may be analyzed, and the portion of the information that relates to the target identified. In step 516, each word in the identified information may be scored based on its relevance and importance to the reputation of the target. The scoring may be done using a dictionary 518 of word sentiment by industry. Dictionary 518 may include information indicating the relevance and importance of particular words in particular industries. For example, in the Information Technology industry, the word “server” may have a particular relevance and importance, while in the restaurant industry, the word “server” may have a different relevance and importance. In step 516, as the words are scored, the score for each piece of information, such as a post, may be accumulated to obtain a score for each piece of information. The scored information from step 516 is stored may be a database 520 of scored information.

In step 522, the scored pieces of information 520 may be ranked in the order that they were found. Weighting of the score of each piece of information may be assigned to the top scoring pieces of information found using each search index. This weighting may be based on stored Weighting by Rank data 524. Weighting by Rank data 524 may indicate weightings to be assigned based on the rank of each scored piece of information among the search results found using each search index. Further, weight may be assigned based on specific sites from which the information was gathered. This weighting may be based on stored Weighting by Site data 526. Weighting by Site data 526 may indicate weightings to be assigned based on the particular site on which each scored piece of information was found. The Weighting by Rank data 524 and the Weighting by Site data 526 may also vary based on the industry to which the target belongs, as well as additional factors.

Finally, in step 510, the reputation score may be computed, based on the categorized information, and on the ranked, scored information, and action may be taken. Such action may include, but is not limited to, action such as that taken in step 408 of FIG. 4, as well as action taken in steps 212, 218, and/or 220 of FIG. 2.

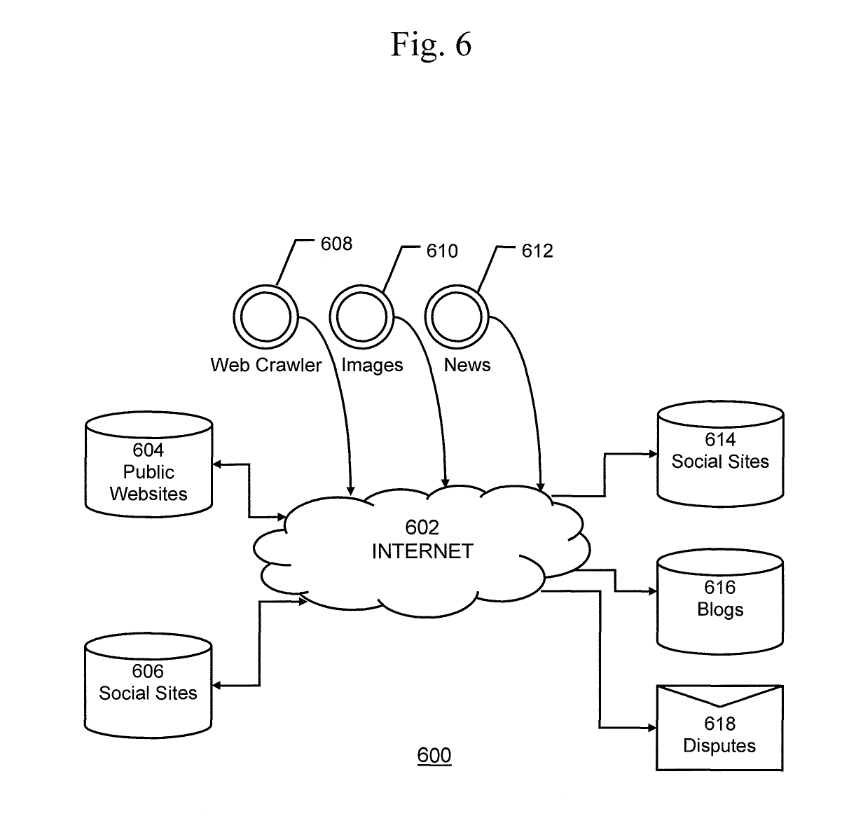

An exemplary block diagram of components and the environment of the system for monitoring online reputations is shown in FIG. 6. The components shown in this example may be used for gathering information as described above. The example shown in FIG. 6 includes, but is not limited to, the public Internet 602, which is communicatively connected to a number of websites, such as public websites 604, social sites 606, etc. Components of the system for monitoring online reputations include information gathering components, such as components 608-612. These components may gather information by performing searches of the Web based on the search terms relating to the target identified as described above. For example, the information gathering components may include Search Engine API Web Crawler 608, Search Engine API Images gathering component 610, Search Engine API News gathering component 612. In the example shown, the information gathering components use search engine APIs to gather their respective types of information. For example, Search Engine API Web Crawler 608 gathers general web information relating to the search terms by crawling the web, Search Engine API Images gathering component 610 gathers images relating to the search terms, and Search Engine API News gathering component 612 gathers news relating to the search terms.

In addition, in this example, information by be generated by the system for monitoring online reputations, as described above. For example, information may be generated and posted to social sites 614 and blogs 616. As described above, such information may include new positive information about the target to be posted to social sites 614 and blogs 616, and may include new social sites and blog sites about the target. Likewise, as described above, information to dispute existing information may be generated. Such information may, for example, include information relating to take down and/or cease and desist letters, legal action, etc.

Although the example shown in FIG. 6 utilized Search APIs to gather information, information may also be gathered without using Search APIs. Rather, searching may be performed using the regular user interfaces of various search sites and tools. In this case the operation of the user interfaces would be automated and controlled by the platform. When performing such searches, it is typical to receive geographically biased search results. That is, the search engine, when operated using its user interface, may determine an approximate or precise location of the computer being used to perform the search, and may present search results targeted to users in that location. To obtain nationwide search results, a network of geographically distributed computer systems may be used to perform the searching, and the locally biased results from each computer system may be read, interpreted, and combined to form nationwide search results. These nationwide results may then be processes similarly to search results obtained using Search APIs.

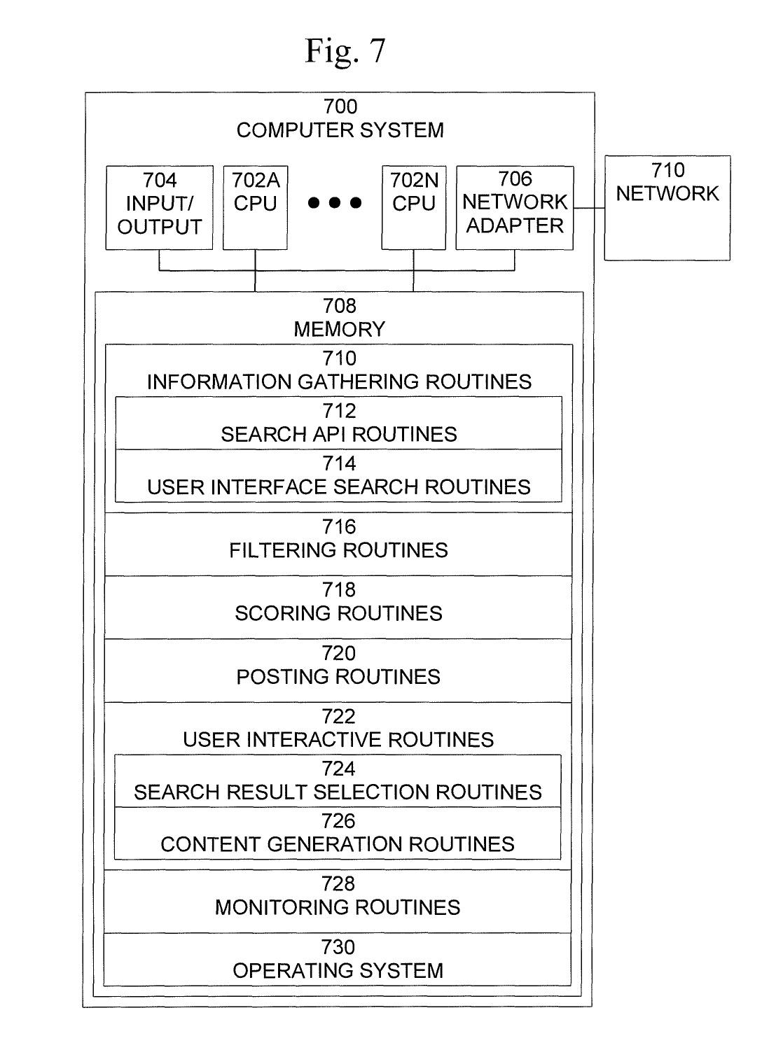

An exemplary block diagram of a computer system 700, in which the processes shown above may be implemented, is shown in FIG. 7. Computer system 700 is typically a programmed general-purpose computer system, such as a personal computer, workstation, server system, and minicomputer or mainframe computer. Computer system 700 includes one or more processors (CPUs) 702A-702N, input/output circuitry 704, network adapter 706, and memory 708. CPUs 702A-702N execute program instructions in order to carry out the functions of the present invention. Typically, CPUs 702A-702N are one or more microprocessors, such as an INTEL PENTIUM® processor. FIG. 7 illustrates an embodiment in which computer system 700 is implemented as a single multi-processor computer system, in which multiple processors 702A-702N share system resources, such as memory 708, input/output circuitry 704, and network adapter 706. However, the present invention also contemplates embodiments in which computer system 700 is implemented as a plurality of networked computer systems, which may be single-processor computer systems, multi-processor computer systems, or a mix thereof.

Input/output circuitry 704 provides the capability to input data to, or output data from, computer system 700. For example, input/output circuitry may include input devices, such as keyboards, mice, touchpads, trackballs, scanners, etc., output devices, such as video adapters, monitors, printers, etc., and input/output devices, such as, modems, etc. Network adapter 706 interfaces device 700 with a network 710. Network 710 may be any public or proprietary LAN or WAN, including, but not limited to the Internet.

Memory 708 stores program instructions that are executed by, and data that are used and processed by, CPU 702 to perform the functions of computer system 700. Memory 708 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 708 varies depending upon the function that computer system 700 is programmed to perform. In the example shown in FIG. 7, memory contents that would be included in a personal computer are shown. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 7, memory 708 may include information gathering routines 710, which may include Search API routines 712 and user interface search routines 714, filtering routines 716, scoring routines 718, posting routines 720, user interactive routines 722, which may include search result selection routines 724 and content generation routines 726, monitoring routines 728, and operating system 730. Information gathering routines 710 gather information relating to the online reputation of the target, such as may be performed by step 402 of FIG. 4. Information gathering routines 710 may include Search API routines 712, which may gather information using Search APIs of websites, and user interface search routines 714, which may gather information without using Search APIs of websites, but rather typically use the user interface of websites. Filtering routines 716 may filter the gathered information, such as may be performed by step 404 of FIG. 4. Scoring routines 718 may score the gathered information and compute the reputation score, such as may be performed by step 406 of FIG. 4. Posting routines 720 may provide the capability, for example, for the platform to post content to a large number of sites automatically, such as may be performed by step 408 of FIG. 4. User interactive routines 722 may provide the capability for the user to interact with the platform to perform various functions. User interactive routines 722 may include search result selection routines 724 and content generation routines 726. Search result selection routines 724 provide the capability for the user to select search results that represent a website or social media profile belonging to them or to select any results that they consider negative or detrimental to their online reputation, such as may be performed in step 208 of FIG. 2. Content generation routines 726 provide the capability for the user to generate content to improve their reputation scores, such as generating positive information, using tools/templates for legal remedies, such as take down and/or cease and desist letters, legal action, etc., such as may be performed by step 408 of FIG. 4. Monitoring routines 728 may provide the capability for the platform to monitor reputation-related information, as well as to determine external trends in the reputation of the target and display the results in real-time, such as may be performed by step 410 of FIG. 4. Operating system 732 provides overall system functionality.

As shown in FIG. 7, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while aspects of the present invention have been described in the context of a fully functioning data processing system, those of ordinary skill in the art will appreciate that the processes of the present invention are capable of being distributed in the form of a computer program product including a computer readable medium of instructions. Examples of non-transitory computer readable media include storage media, examples of which include, but are not limited to, floppy disks, hard disk drives, CD-ROMs, DVD-ROMs, RAM, and, flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of monitoring and affecting online reputation comprising:
gathering information potentially related to an online reputation of a target;
filtering the gathered information to eliminate information not related to the target;
computing a reputation score for the filtered information based on both positive and negative information related to the target;
generating positive information relating to the target; and
distributing the generated positive information relating to the target to a plurality of online locations.

2. The method of claim 1, wherein the information is gathered from a plurality of online locations, at least one online location provided by the target or a representative of the target, and at least one online location found in a keyword search.

3. The method of claim 2, wherein the keyword search is performed using at least one search engine and using at least one search term found by crawling the keyword search tools of the search engine to find search terms used in connection with a specific root keyword.

4. The method of claim 1, wherein the filtering is performed based on at least one of geographic location, employer, company, interest, hobby, and keywords.

5. The method of claim 4, wherein the filtering is performed based on input provided by the target or a representative of the target indicating whether or not particular information or a particular online location is related to the target.

6. The method of claim 1, wherein the reputation score is computed by:
for each piece of gathered information relating to the target:
scoring each word in the piece of gathered information using information indicating relevance and importance of particular words in particular industries, and
accumulating the total score for the piece of gathered information;
for each of a plurality of highest scored pieces of gathered information:
weighting the score of the piece of information based on a rank of the piece of information among the gathered information, and
weighting the score of the piece of information based on a specific online location from which the piece of information was gathered; and
computing the reputation score from the weighted scores of the plurality of the highest scored pieces of gathered information.

7. The method of claim 1, wherein positive information relating to the target is generated by at receiving positive information from the target or a representative of the target.

8. The method of claim 1, wherein the generated positive information is distributed to a plurality of online locations by:
performing at least one of:
automatically logging into at least one online location controlled by the target or a representative of the target, including at least one of a social media account, a blog account, and a website owned or controlled by the target or a representative of the target,
automatically creating at least one online location controlled by the target or a representative of the target, including at least one of a social media account and a blog account, and
automatically obtaining a domain name and creating a website owned or controlled by the target or a representative of the target; and
distributing the generated positive information to the plurality of online locations.

9. A system for monitoring and affecting online reputation comprising a processor operable to execute computer program instructions, a memory operable to store computer program instructions executable by the processor, and computer program instructions stored in the memory and executable to perform:
gathering information potentially related to an online reputation of a target;
filtering the gathered information to eliminate information not related to the target;
computing a reputation score for the filtered information based on both positive and negative information related to the target;
generating positive information relating to the target; and
distributing the generated positive information relating to the target to a plurality of online locations.

10. The system of claim 9, wherein the information is gathered from a plurality of online locations, at least one online location provided by the target or a representative of the target, and at least one online location found in a keyword search.

11. The system of claim 10, wherein the keyword search is performed using at least one search engine and using at least one search term found by crawling the keyword search tools of the search engine to find search terms used in connection with a specific root keyword.

12. The system of claim 9, wherein the filtering is performed based on at least one of geographic location, employer, company, interest, hobby, and keywords.

13. The system of claim 12, wherein the filtering is performed based on input provided by the target or a representative of the target indicating whether or not particular information or a particular online location is related to the target.

14. The system of claim 9, wherein the reputation score is computed by:
for each piece of gathered information relating to the target:
scoring each word in the piece of gathered information using information indicating relevance and importance of particular words in particular industries, and
accumulating the total score for the piece of gathered information;
for each of a plurality of highest scored pieces of gathered information:
weighting the score of the piece of information based on a rank of the piece of information among the gathered information, and
weighting the score of the piece of information based on a specific online location from which the piece of information was gathered; and
computing the reputation score from the weighted scores of the plurality of the highest scored pieces of gathered information.

15. The system of claim 9, wherein positive information relating to the target is generated by at receiving positive information from the target or a representative of the target.

16. The system of claim 9, wherein the generated positive information is distributed to a plurality of online locations by:
performing at least one of:
automatically logging into at least one online location controlled by the target or a representative of the target, including at least one of a social media account, a blog account, and a website owned or controlled by the target or a representative of the target,
automatically creating at least one online location controlled by the target or a representative of the target, including at least one of a social media account and a blog account, and
automatically obtaining a domain name and creating a website owned or controlled by the target or a representative of the target; and
distributing the generated positive information to the plurality of online locations.

17. A computer program product for monitoring and affecting online reputation comprising a non-transitory computer readable medium having recorded thereon computer program instructions, the computer program instructions executable by at least one processor to perform:
gathering information potentially related to an online reputation of a target;
filtering the gathered information to eliminate information not related to the target;
computing a reputation score for the filtered information based on both positive and negative information related to the target;
generating positive information relating to the target; and
distributing the generated positive information relating to the target to a plurality of online locations.

18. The computer program product of claim 17, wherein the information is gathered from a plurality of online locations, at least one online location provided by the target or a representative of the target, and at least one online location found in a keyword search.

19. The computer program product of claim 18, wherein the keyword search is performed using at least one search engine and using at least one search term found by crawling the keyword search tools of the search engine to find search terms used in connection with a specific root keyword.

20. The computer program product of claim 17, wherein the filtering is performed based on at least one of geographic location, employer, company, interest, hobby, and keywords.

21. The computer program product of claim 20, wherein the filtering is performed based on input provided by the target or a representative of the target indicating whether or not particular information or a particular online location is related to the target.

22. The computer program product of claim 17, wherein the reputation score is computed by:
for each piece of gathered information relating to the target:
scoring each word in the piece of gathered information using information indicating relevance and importance of particular words in particular industries, and
accumulating the total score for the piece of gathered information;
for each of a plurality of highest scored pieces of gathered information:
weighting the score of the piece of information based on a rank of the piece of information among the gathered information, and
weighting the score of the piece of information based on a specific online location from which the piece of information was gathered; and
computing the reputation score from the weighted scores of the plurality of the highest scored pieces of gathered information.

23. The computer program product of claim 17, wherein positive information relating to the target is generated by at receiving positive information from the target or a representative of the target.

24. The computer program product of claim 17, wherein the generated positive information is distributed to a plurality of online locations by:
performing at least one of:
automatically logging into at least one online location controlled by the target or a representative of the target, including at least one of a social media account, a blog account, and a website owned or controlled by the target or a representative of the target,
automatically creating at least one online location controlled by the target or a representative of the target, including at least one of a social media account and a blog account, and
automatically obtaining a domain name and creating a website owned or controlled by the target or a representative of the target; and
distributing the generated positive information to the plurality of online locations.
